(19) United States
(12) Patent Application Publication
(10) Pub. No.: US 2005/0217519 A1
(43) Pub. Date: Oct. 6, 2005

(54) Stencil printing machine

(76) Inventors: Taku Naitou, Ibaraki-ken (JP); Akira Nakamura, Ibaraki-ken (JP)

Correspondence Address: NATH & ASSOCIATES, PLLC, Sixth Floor, 1030 15th Street, N.W., Washington, DC, 20005, US

(21) Appl. No.: 11/098,564

(22) Filed: Apr. 5, 2005

(30) Foreign Application Priority Data
Apr. 6, 2004 (JP) P2004-111839
Apr. 6, 2004 (JP) P2004-111843

(51) Int. Cl. B41L 13/18

(52) U.S. Cl. 101/119

(57) ABSTRACT

A stencil printing machine, which includes: a drum which is freely rotatable and has an outer peripheral wall formed of an ink impermeable member, in which a stencil sheet is mounted on a surface of the outer peripheral wall; an ink supplying device which has an ink supply port on the outer peripheral wall of the drum and has an ink tank storing an ink, and supplies the ink, which is guided from the ink tank, from the ink supply port to a surface of the outer peripheral wall; an ink recovery device which has an ink recovery port on the outer peripheral wall of the drum, and recovers, from the ink recovery port, an extra ink on the surface of the outer peripheral wall; and a pressure roller which presses a print sheet fed thereto to the outer peripheral wall. The ink recovery device is configured to recover, to the ink tank, the extra ink recovered from the ink recovery port.

### BACKGROUND OF THE INVENTION

1. Field of the Invention

The present invention relates to a stencil printing machine which conveys a print medium while pressing the print medium to a drum on which a stencil sheet is mounted, and transfers an ink oozing from perforations of the stencil sheet onto the print medium.

2. Description of the Related Art

As a conventional printing method of a stencil printing machine, there are an inner press method (refer to Japanese Patent Laid-Open Publication No. Hei 7-132675 (published in 1995)) and an outer press method (refer to Japanese Patent Laid-Open Publication No. 2001-246828).

The inner press method is briefly described. As shown in FIG. 1, a drum 100 and a back press roller 101 are provided, and the drum 100 and the back press roller 101 are provided so as to be freely rotatable individually in a state where outer peripheral surfaces thereof are partially made substantially adjacent to each other. A stencil clamping portion 100a which clamps a tip end of a stencil sheet 104 is provided on the outer peripheral surface of the drum 100, and an outer peripheral wall other than the stencil clamping portion 100a is formed of a screen 102 which is flexible and ink permeable.

An ink supply mechanism 105 is provided inside the drum 100. As shown in FIG. 2, this ink supply mechanism 105 includes an inner press roller 106 which is an ink supply roller, and the inner press roller 106 is provided on a roller support member 107 so as to be freely rotatable. The inner press roller 106 is configured to be shiftable between a press position where the roller support member 107 is energized in a direction of an arrow a of FIG. 2 to press an inner peripheral surface of the screen 102 and a standby position where the roller support member 107 is rotated in a direction of an arrow b of FIG. 2 to be spaced from the inner peripheral surface of the screen 102. The inner press roller 106 is set at the press position when a print sheet 111 passes therethrough, and otherwise, set at the standby position. Moreover, the inner press roller 106 has a function to apply printing pressure from an inner periphery side of the screen 102.

The roller support member 107 is supported so as to be freely rotatable about a support shaft 108, and a doctor roller 109 and a drive rod 110 are individually provided on the roller support member 107. The doctor roller 109 has a cylindrical shape, and is fixed to the roller support member 107 at a position close to the inner press roller 106. The drive rod 110 is supported on the roller support member 107 so as to be freely rotatable, and is placed in an upper space composed of outer peripheral surfaces of the inner press roller 106 and the doctor roller 109 on sides thereof adjacent to each other. An ink 103 is supplied from an ink supply unit (not shown) to the upper space.

Next, printing operations are schematically described in order. The stencil sheet 104 on which a perforated image is formed is attached onto an outer peripheral surface of the screen 102. Then, during a printing mode, the drum 100 and the back press roller 101 are rotated in synchronization with each other in directions shown in arrows in FIG. 1, and the print sheet 111 is fed between the drum 100 and the back press roller 101.

When the print sheet 111 is fed, the inner press roller 106 presses the screen 102, and the inner press roller 106 rotates following the drum 100 in such a pressing state. The ink 103 having passed through a gap between the inner press roller 106 and the doctor roller 109 is adhered onto the outer peripheral surface of the inner press roller 106, and the ink 103 thus adhered is sequentially supplied to an inner surface of the screen 102 by the rotation of the inner press roller 106.

Moreover, when the inner press roller 106 presses the screen 102, the screen 102 swells out to the outer periphery side thereof by pressing force at this time, and the screen 102 is put into a press-contact state with the back press roller 101. Then, the print sheet 111 conveyed between the drum 100 and the back press roller 101 is conveyed while being brought into press contact with the screen 102 and the stencil sheet 104 in between the inner press roller 106 and the back press roller 101. By press-contact force at this time, the ink 103 on the screen 102 side is transferred to the print sheet 111 side from perforations of the stencil sheet 104, and an ink image is printed on the print sheet 111.

The outer press method is briefly described. As shown in FIG. 3, a drum 120 is provided. A stencil clamping portion 120a which clamps the tip end of the stencil sheet 104 is provided on an outer peripheral surface of this drum 120, and an outer peripheral wall 120b other than the stencil clamping portion 120a is formed of an ink permeable member with a porous structure.

An ink supply mechanism 125 is provided inside the drum 120. The ink supply mechanism 125 includes a squeegee roller 126 supported so as to be freely rotatable, and a doctor roller 127 placed adjacent to the squeegee roller 126. An ink 128 accumulates in an outer peripheral space surrounded by the squeegee roller 126 and the doctor roller 127. The ink 128 adhered onto the outer periphery of the rotating squeegee roller 126 passes through a gap between the squeegee roller 126 and the doctor roller 127, and thus only the ink 128 with a predetermined film thickness is adhered onto the squeegee roller 126, and the ink 128 with the predetermined film thickness is supplied to an inner surface of the outer peripheral wall 120b.

Moreover, a pressure roller 130 is provided at a position opposite to the squeegee roller 126, which is also an outside position of the drum 120. The pressure roller 130 is configured to be shiftable between a press position of pressing the outer peripheral wall 120b of the drum 120 and a standby position of being spaced from the outer peripheral wall 120b of the drum 120. The squeegee roller 126 is fixed to a support member which supports the outer peripheral wall 120b of the drum 120 so as to be freely rotatable, and an outer peripheral surface of the squeegee roller 126 and the inner peripheral surface of the outer peripheral wall 120b of the drum 120 are brought into a state of being slightly spaced from each other in a state where the outer peripheral wall 120b of the drum 120 is not pressed by the pressure roller 130. When the outer peripheral wall 120b of the drum 120 is pressed by the pressure roller 130, the outer peripheral wall 120b of the drum 120 is bent, and thus the outer peripheral surface of the squeegee roller 126 and the inner peripheral surface of the outer peripheral wall 120b of the drum 120 are brought into contact with each other.

Next, printing operations are schematically described in order. The stencil sheet 104 on which the perforated image is formed is attached onto an outer peripheral surface of the outer peripheral wall 120b of the drum 120. Then, during the printing mode, the outer peripheral wall 120b of the drum 120 is rotated in a direction shown by an arrow in FIG. 3, and the print sheet 111 is fed between the drum 120 and the pressure roller 130.

When the print sheet 111 is fed, the pressure roller 130 presses the outer peripheral wall 120b of the drum 120, and the outer peripheral wall 120b is shifted toward an inner periphery side thereof. The outer peripheral wall 120b is brought into a pressed state on the squeegee roller 126 by such shifting, and the squeegee roller 126 rotates following the drum 120. Onto the outer peripheral surface of the squeegee roller 126, the ink 128 having passed through the gap between the squeegee roller 126 and the doctor roller 127 is adhered. The ink 128 thus adhered is sequentially supplied to an inner surface of the outer peripheral wall 120b by the rotation of the squeegee roller 126.

Moreover, when the pressure roller 130 presses the outer peripheral wall 120b of the drum 120, the print sheet 111 conveyed between the drum 120 and the pressure roller 130 is conveyed while being brought into press contact with the stencil sheet 104 in between the squeegee roller 126 and the pressure roller 130. By press-contact force at this time, the ink 128 on the outer peripheral wall 120b side is transferred to the print sheet 111 side from the perforations of the stencil sheet 104, and an ink image is printed on the print sheet 111.

However, in the stencil printing machines of the conventional inner press method and outer press method, ink pools are individually formed in the outer peripheral space of the inner press roller 106 and the doctor roller 109 and in the outer peripheral space of the squeegee roller 126 and the doctor roller 127, and the inks 103 and 128 in the ink pools are supplied to the screen 102 and outer peripheral wall 120b of the drums 100 and 120 at the time of printing. Here, the inks 103 and 128 in the ink pools and the inks 103 and 128 adhered onto the drums 100 and 120 and the like are held at the positions concerned even after the printing is finished, and are used for the next printing and after. Hence, when the next printing and after are not performed for a long time, the inks 103 and 128 having accumulated in the ink pools and the inks 103 and 128 adhered onto the drums 100 and 120 and the like are left standing in a state of being in contact with the atmosphere, and the inks 103 and 128 are thus degraded. When the printing is performed by using the inks 103 and 128 thus degraded, desired image quality is not obtained. Accordingly, it has been necessary to discard the degraded inks by performing disposal printing and so on, leading to a problem of much ink waste.

### SUMMARY OF THE INVENTION

In this connection, it is an object of the present invention to provide a stencil printing machine capable of eliminating the ink waste by surely preventing the degradation of the ink, and of automatically using recovered ink for the next printing and after.

In order to achieve the foregoing object, a first aspect of the present invention provides a stencil printing machine, which includes: a drum which is freely rotatable and has an outer peripheral wall formed of an ink impermeable member, in which a stencil sheet is mounted on a surface of the outer peripheral wall; an ink supplying device which has an ink supply unit provided on the outer peripheral wall of the drum and has an ink tank storing ink, and supplies the ink from the ink supply unit to the surface of the outer peripheral wall, the ink being guided from the ink tank; an ink recovery device which has an ink recovery unit on the outer peripheral wall of the drum, and recovers, from the ink recovery unit, an extra ink on the surface of the outer peripheral wall; and a pressure roller which presses a print medium fed thereto to the outer peripheral wall, wherein the ink recovery device recovers, to the ink tank, the extra ink recovered from the ink recovery unit.

In the stencil printing machine, the extra ink which is not used for the printing on the outer peripheral wall of the drum is recovered by the ink recovery device, and the extra ink thus recovered is recovered into the ink tank of the ink supplying device. Hence, such a situation where the extra ink is degraded on the outer peripheral wall of the drum can be surely prevented to eliminate waste of the ink, and in addition, the recovered ink can be automatically used for the next printing and after.

In a preferred embodiment of the present invention, a filter which traps impurities in the ink may be interposed in a passage for recovering the ink from the ink recovery unit to the ink tank.

In the stencil printing machine, the ink recovered from the outer peripheral wall of the drum passes through the filter, and impurities such as paper dust in the ink are trapped by the filter. Hence, quality of the recovered ink can be improved.

Moreover, the ink supplying device and the ink recovery device may always be driven during a printing mode.

In the stencil printing machine, during the printing mode, the ink is continuously supplied from the ink supply port to the outer peripheral wall, and the ink which has entered the ink recovery port from the outer peripheral wall is always recovered. Accordingly, the ink can be prevented from building up on the outer peripheral wall. Moreover, an adequate amount of the ink can always be held on the outer peripheral wall, and accordingly, even when a large number of the print sheets are continuously printed, printed sheets with a desired ink density can be obtained.

Furthermore, a drive of the ink recovery device may be stopped a little later than a stop of a drive of the ink supplying device when the printing mode is finished.

In the stencil printing machine, the extra ink cannot be allowed to remain in a substantially hermetically sealed space between the outer peripheral wall of the drum and the stencil sheet. Hence, such situation where the extra ink is degraded on the outer peripheral wall of the drum can be further prevented, and the waste of the ink can be eliminated more effectively.

### BRIEF DESCRIPTION OF THE DRAWINGS

FIG. 1 is a schematic view of principal portions for printing according to an inner press method of a conventional example.

FIG. 2 is a schematic view of an ink supplying device according to the inner press method of the conventional example.

FIG. 3 is a schematic view of principal portions for printing according to an outer press method according to the conventional example.

FIG. 4 shows a first embodiment of the present invention, and is a schematic configuration view of a stencil printing machine.

FIG. 5 shows the first embodiment of the present invention, and is a perspective view of a drum.

FIG. 6 shows the first embodiment of the present invention, and is a cross-sectional view along a line 6-6 in FIG. 5.

FIG. 7 shows the first embodiment of the present invention, and is a cross-sectional view along a line 7-7 in FIG. 5.

FIG. 8 shows the first embodiment of the present invention, and is a partial cross-sectional view explaining a diffusion mechanism of an ink.

FIG. 9 shows a first modification example of an ink recovery device of the first embodiment of the present invention, and is a schematic configuration view of the ink supplying device and the ink recovery device.

FIG. 10 shows a second modification example of the ink recovery device of the first embodiment of the present invention, and is a schematic configuration view of the ink supplying device and the ink recovery device.

FIG. 11 shows a third modification example of the ink recovery device of the first embodiment of the present invention, and is a schematic configuration view of the ink supplying device and the ink recovery device.

FIG. 12 shows a second embodiment of the present invention, and is a perspective view a drum.

FIG. 13 shows the second embodiment of the present invention, and is a cross-sectional view along a line 13-13 in FIG. 12.

FIG. 14 shows the second embodiment of the present invention, and is a cross-sectional view along a line 14-14 in FIG. 12.

FIG. 15 shows the second embodiment of the present invention, and is a cross-sectional view along a line 15-15 in FIG. 12.

FIG. 16 shows a third embodiment of the present invention, and is a perspective view of a drum.

### DETAILED DESCRIPTION OF THE PREFERRED EMBODIMENTS

A first embodiment of the present invention is described below based on the drawings.

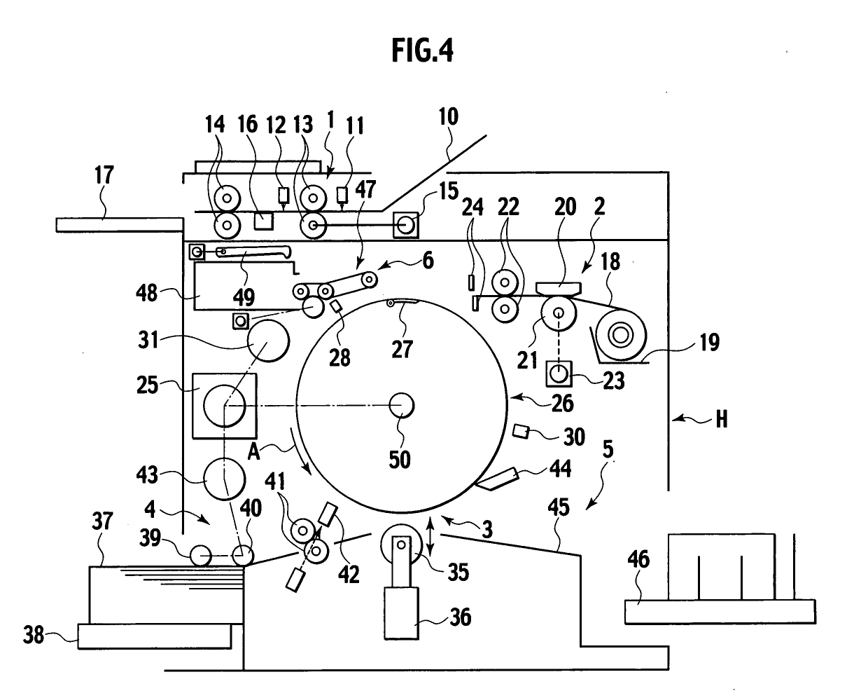

As shown in FIG. 4, a stencil printing machine is mainly composed of an original reading unit 1, a stencil making unit 2, a printing unit 3, a paper feed unit 4, a paper discharge unit 5, and a stencil disposal unit 6.

The original reading unit 1 includes an original setting tray 10 on which an original to be printed is mounted, reflective-type original sensors 11 and 12 which detect the presence of the original on the original setting tray 10, original conveyer rollers 13 and 14 which convey the original on the original setting tray 10, a stepping motor 15 which rotationally drives the original conveyer rollers 13 and 14, a contact image sensor 16 which optically reads image data of the original conveyed by the original conveyer rollers 13 and 14 and converts the read data into electrical signals, and an original discharge tray 17 on which the original discharged from the original setting tray 10 is mounted. The original mounted on the original setting tray 10 is conveyed by the original conveyer rollers 13 and 14, and the image sensor 16 reads the image data of the conveyed original.

The stencil making unit 2 includes a stencil housing 19 which houses a long and rolled stencil sheet 18, a thermal print head 20 placed downstream of the stencil housing 19 in a conveying direction, a platen roller 21 placed at a position opposite to the thermal print head 20, a pair of stencil transfer rollers 22 and 22 placed downstream of the platen roller 21 and the thermal print head 20 in the conveying direction, a write pulse motor 23 which rotationally drives the platen roller 21 and the stencil transfer rollers 22 and 22, and a stencil cutter 24 placed downstream of the pair of stencil transfer rollers 22 and 22 in the conveying direction.

The long stencil sheet 18 is conveyed by the rotation of the platen roller 21 and the stencil transfer rollers 22 and 22. Based on the image data read by the image sensor 16, each of dot-shaped heating elements of the thermal print head 20 selectively performs a heating operation, and thus the stencil sheet 18 is perforated due to thermal sensitivity thereof to make a stencil. Then, the stencil sheet 18 thus made is cut by the stencil cutter 24 to make the stencil sheet 18 with a predetermined length.

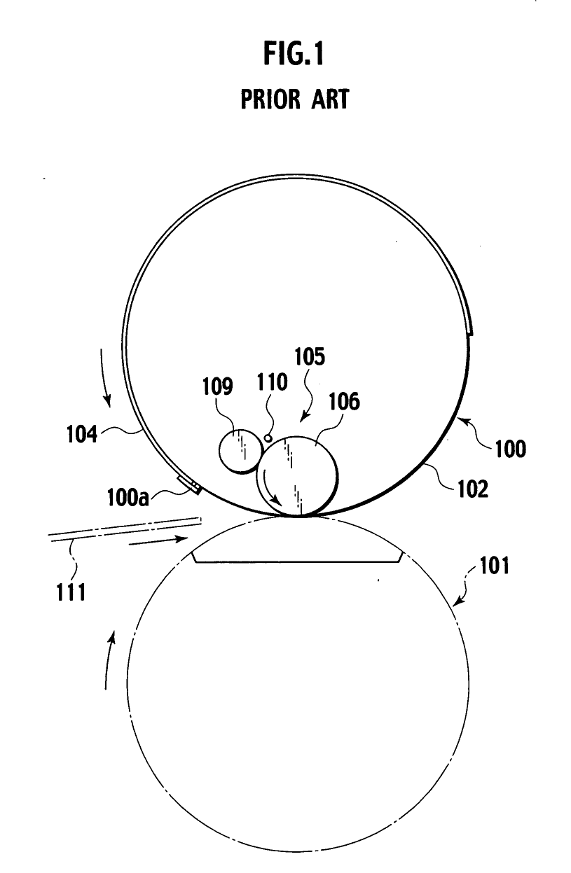

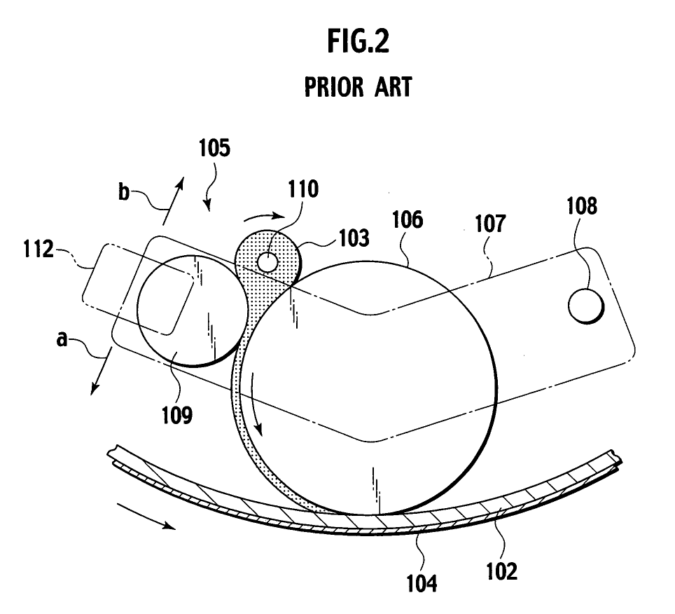

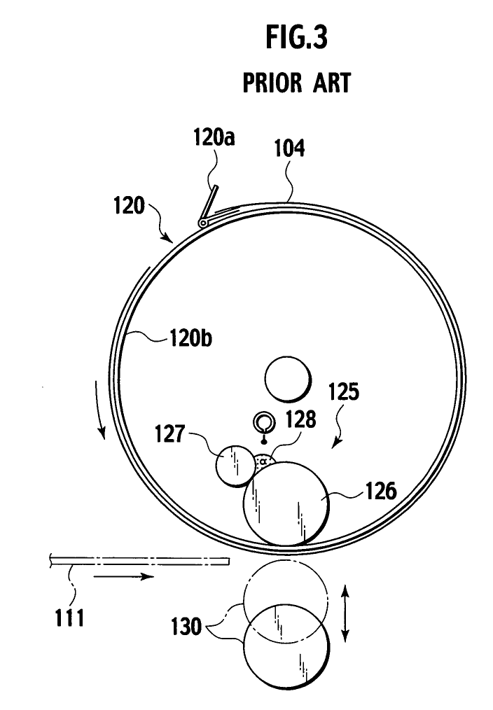

The printing unit 3 includes a drum 26 which rotates in a direction of an arrow A of FIG. 1 by driving force of a main motor 25, a stencil clamping portion 27 which is provided on an outer peripheral surface of the drum 26 and clamps a tip end of the stencil sheet 18, an ink supplying device 54 which supplies an ink to the surface of the drum 26, and an ink recovery device 73 which recovers an extra ink on the surface of the drum 26.

Moreover, the printing unit 3 includes a stencil confirming sensor 28 which detects whether or not the stencil sheet 18 is wound and attached around the outer peripheral surface of the drum 26, a reference position detecting sensor 30 which detects a reference position of the drum 26, and a rotary encoder 31 which detects rotation of the main motor 25. Based on a detection output of the reference position detecting sensor 30, a pulse outputted from the rotary encoder 31 is detected, thus enabling a rotation position of the drum 26 to be detected.

Furthermore, the printing unit 3 includes a pressure roller 35 placed below the drum 26. The pressure roller 35 is constructed to be shiftable between a press position of pressing the outer peripheral wall of the drum 26 by driving force of a solenoid device 36 and a standby position of being spaced from the outer peripheral surface of the drum 26. The pressure roller 35 is always located at the press position during a period of a printing mode (including a trial print mode) and located at the standby position during a period other than the period of the printing mode.

Then, the tip end of the stencil sheet 18 conveyed from the stencil making unit 2 is clamped by the stencil clamping portion 27, and the drum 26 is rotated in such a clamping state, so that the stencil sheet 18 is wound and attached around the outer peripheral surface of the drum 26. Then, print sheets (print media) 37, which are fed by the paper feed unit 4 in synchronization with the rotation of the drum 26, are pressed to the stencil sheet 18 wound around the drum 26 by the pressure roller 35. Thus, ink 56 is transferred from perforations of the stencil sheet 18 onto the print sheets 37, and an image is printed thereon.

The paper feed unit 4 includes a paper feed tray 38 on which the print sheets 37 are stacked, first paper feed rollers 39 and 40 which convey only the uppermost print sheet 37 from the paper feed tray 38, a pair of second paper feed rollers 41 and 41 which convey the print sheet 37, which has been conveyed by the first paper feed rollers 39 and 40, between the drum 26 and the pressure roller 35 in synchronization with the rotation of the drum 26, and a paper feed sensor 42 which detects whether or not the print sheet 37 has been conveyed between the pair of second paper feed rollers 41 and 41. The first paper feed rollers 39 and 40 are constructed such that the rotation of the main motor 25 is selectively transmitted thereto through a paper feed clutch 43.

The paper discharge unit 5 includes a sheet separator claw 44 which separates the printed print sheets 37 from the drum 26, a conveying passage 45 through which the print sheets 37 separated from the drum 26 by the sheet separator claw 44 are conveyed, and a paper receiving tray 46 on which the print sheets 37 discharged from the conveying passage 45 are mounted.

The stencil disposal unit 6 includes a disposed stencil conveying device 47, a stencil disposal box 48, and a disposed stencil compression member 49. The disposed stencil conveying device 47 guides the tip end of the stencil sheet 18, of which clamping has been released from the outer peripheral surface of the drum 26, and conveys the used stencil sheet 18 thus guided while peeling off the same stencil sheet 18 from the drum 26. The stencil disposal box 48 houses the stencil sheet 18 conveyed by the disposed stencil conveying device 47. The disposed stencil compression member 49 pushes the stencil sheet 18, which has been conveyed by the disposed stencil conveying device 47 into the stencil disposal box 48, into a bottom of the stencil disposal box 48.

Next, configurations of the drum 26, the stencil clamping portion 27, the ink supplying device 54 and the ink recovery device 73 are described.

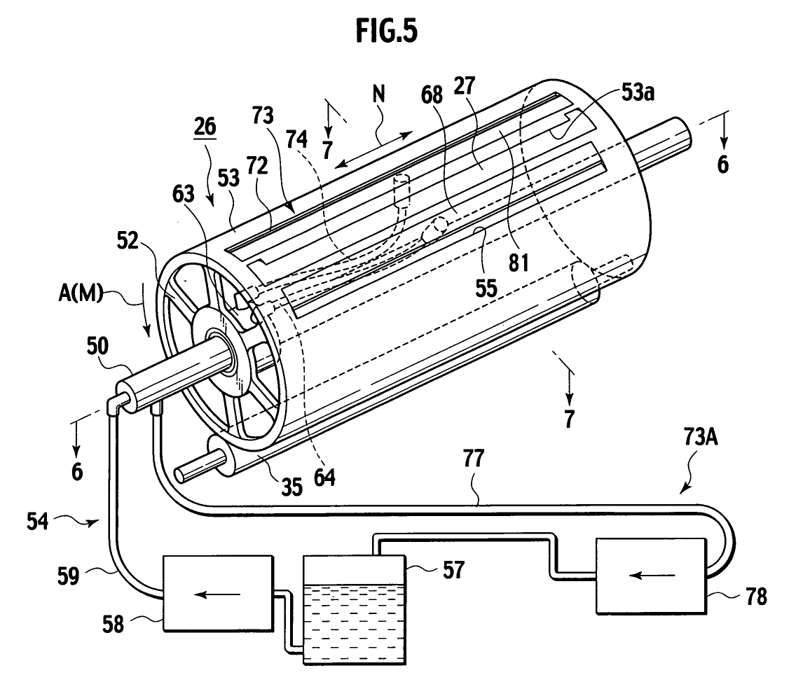

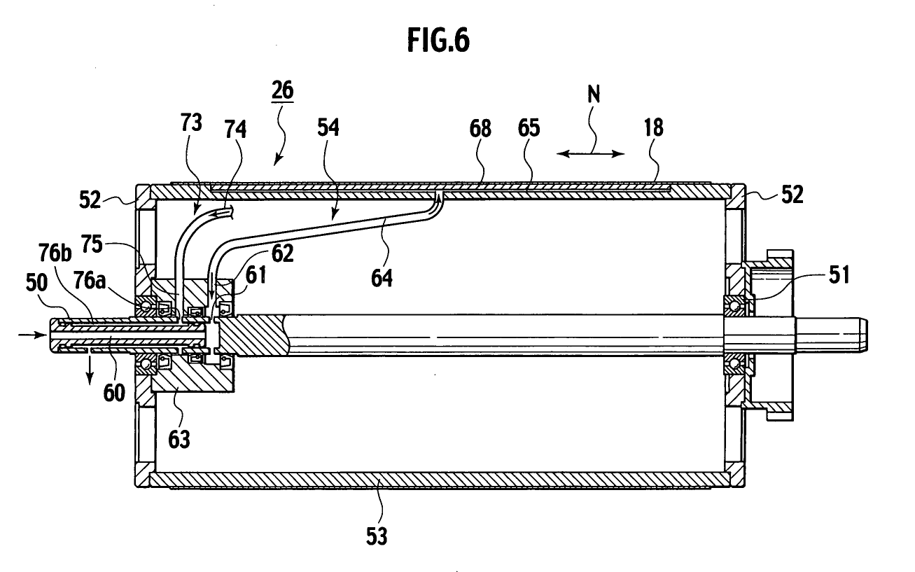

As shown in FIG. 5 to FIG. 7, the drum 26 includes a support shaft 50 fixed to a machine body H (shown in FIG. 4), a pair of side disks 52 and 52 supported on the support shaft 50 so as to be freely rotatable with bearings 51 interposed therebetween, respectively, and a cylindrical outer peripheral wall 53 fixed between the pair of side disks 52 and 52. The outer peripheral wall 53 is rotationally driven by rotation force of the main motor 25 integrally with the pair of side disks 52 and 52. Moreover, the outer peripheral wall 53 has rigidity, and is formed of an ink impermeable member which does not allow the ink 56 to permeate therethrough. Note that, depending on a type of the ink impermeable member, the outer peripheral surface of the outer peripheral wall 53 may be subjected to various kinds of surface processing known in public, such as a fluorine-contained resin coating process such as a Teflon® coating process, nickel plating, nickel chromium plating, fused zinc plating and anodic treatment for the purpose of forming the outer peripheral surface concerned into an even cylindrical surface.

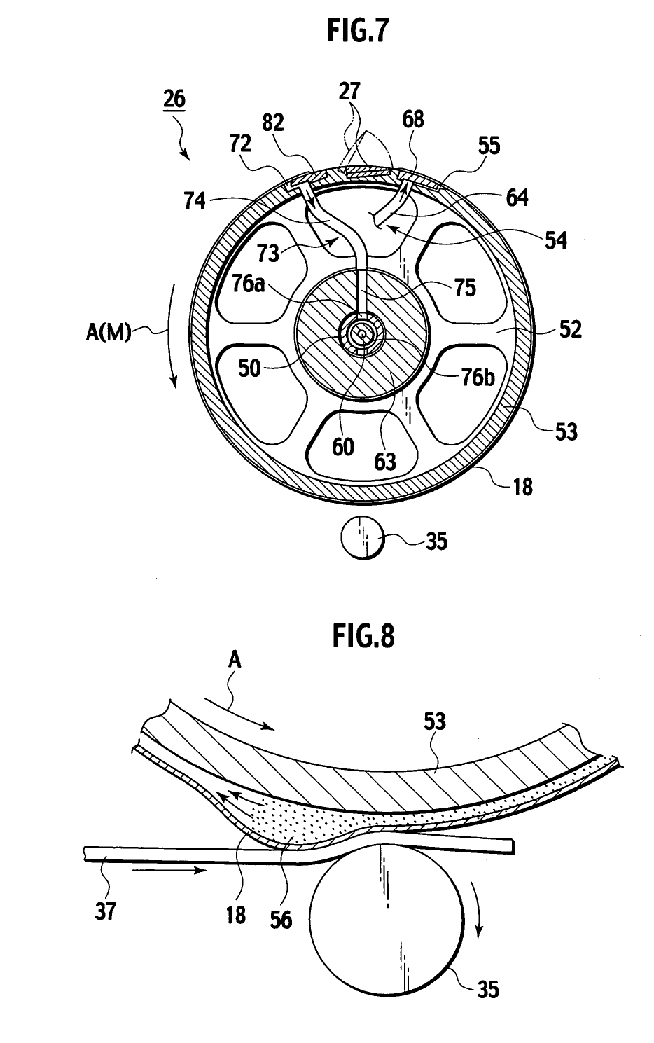

The stencil clamping portion 27 is provided by use of a concave clamping portion 53a formed on the outer peripheral wall 53 along an axial direction of the support shaft 50. One end of the stencil clamping portion 27 is supported on the outer peripheral wall 53 such that the stencil clamping portion 27 is freely rotatable. The stencil clamping portion 27 is provided so as not to protrude from the outer peripheral wall 53 in a clamping state shown by a solid line in FIG. 7 while the stencil clamping portion 27 protrudes from the outer peripheral wall 53 in a clamping release state shown by a virtual line in FIG. 7. Hence, the stencil clamping portion 27 is configured to be capable of clamping the stencil sheet 18 without protruding from the outer peripheral wall 53.

The outer peripheral wall 53 is rotated in the direction of the arrow A of FIG. 5 and FIG. 7, and a position thereof rotated a little from the stencil clamping portion 27 is set at a printing start point. Hence, the rotation direction A becomes a printing direction M, and an area that follows the printing start point is set as a printing area. In this first embodiment, the maximum printing area is set at a region sufficient for printing an A3-size sheet. Moreover, an ink supply port 55 of the ink supplying device 54 is provided upstream of the maximum printing area of the outer peripheral wall 53 in the printing direction M.

As shown in FIG. 5 to FIG. 7, the ink supplying device 54 includes an ink tank 57 in which the ink is stored, an ink pump 58 which suctions the ink in the ink tank 57, a first pipe 59 which supplies the ink suctioned by the ink pump 58, the support shaft 50 to which the other end of the first pipe 59 is connected and in which an ink passage 60 is formed and a hole 61 is formed at a position 180 degrees opposite thereto, a rotary joint 63 which is supported on an outer periphery of the support shaft 50 so as to be freely rotatable and in which a through hole 62 that is able to communicate with the hole 61 is formed, a second pipe 64 in which one end thereof is connected to the rotary joint 63 and the other end thereof is guided to the outer peripheral wall 53, and the ink supply port 55 to which the other end of the second pipe 64 is connected and which is open to the surface of the outer peripheral wall 53.

The ink supply port 55 is formed by use of an ink supplying concave portion continuously formed along a direction N perpendicular to the printing direction of the outer peripheral wall 53, and of an ink distribution member 68 formed inside the ink supplying concave portion.

As shown in FIG. 5 to FIG. 7, the ink recovery device 73 is composed of an ink recovery port 72 as an ink recovery unit open at a position downstream of the maximum printing area of the outer peripheral wall 53 in the printing direction, a third pipe 74 in which one end is connected to the ink recovery port 72, the rotary joint 63 to which the other end of the third pipe 74 is connected and in which a communication hole 75 is formed, the support shaft 50, a fourth pipe 77 in which one end is connected to the support shaft 50, and an ink pump (for example, trochoid pump) 78 which is interposed midway through the fourth pipe 77 and suctions the ink 56 in the fourth pipe 77. Here, regarding the support shaft 50, the rotary joint 63 is supported thereon so as to be freely rotatable, a hole 76a to which the communication hole 75 is connectable is formed therein, and an ink passage 76b is formed in the inside thereof. The other end of the fourth pipe 77 is connected into the ink tank 57 of the ink supplying device 54.

The ink recovery port 72 is formed by use of an ink recovery concave portion continuously formed along the perpendicular-to-printing direction N of the outer peripheral wall 53, and a pipe fixing member 82 placed in the inside thereof.

The rotary joint 63 is made to also function as one for the ink supplying device 54. Moreover, the support shaft 50 is also used as one for an ink passage of the ink supplying device 54, and accordingly, adopts a structure of a double pipe.

Next, operations of the stencil printing machine configured as described above are briefly described.

First, when a stencil making mode is selected, in the stencil making unit 2, the stencil sheet 18 is conveyed by the rotation of the platen roller 21 and the stencil transfer rollers 22 and 22. Based on the image data read by the original reading unit 1, a large number of heating elements of the thermal print head 20 selectively perform the heating operation, and thus the stencil sheet 18 is perforated due to the thermal sensitivity thereof to make the stencil. Then, the stencil sheet 18 thus made is cut at the predetermined spot by the stencil cutter 24. Thus, the stencil sheet 18 with the desired dimension is made.

In the printing unit 3, the tip end of the stencil sheet 18 made in the stencil making unit 2 is clamped by the stencil clamping portion 27 of the drum 26, and the drum 26 is rotated in such a clamping state, so that the stencil sheet 18 is wound, attached and loaded around the outer peripheral surface of the drum 26.

Next, when the printing mode is selected, in the printing unit 3, the drum 26 is rotationally driven, and the ink supplying device 54 and the ink recovery device 73 start driving. Then, the ink 56 is supplied from the ink supply port 55 to the outer peripheral wall 53, and the ink 56 thus supplied is held between the outer peripheral wall 53 and the stencil sheet 18, and the pressure roller 35 is shifted from the standby position to the press position.

The paper feed unit 4 feeds the print sheets 37 between the drum 26 and the pressure roller 35 in synchronization with the rotation of the drum 26. The print sheets 37 thus fed are pressed to the outer peripheral wall 53 of the drum 26 by the pressure roller 35, and conveyed by the rotation of the outer peripheral wall 53 of the drum 26. Specifically, the print sheets 37 are conveyed while being brought into intimate contact with the stencil sheet 18.

Moreover, at the same time when the print sheets 37 are conveyed, as shown in FIG. 8, the ink 56 held between the outer peripheral wall 53 of the drum 26 and the stencil sheet 18 is diffused downstream in the printing direction M while being squeezed by the pressing force of the pressure roller 35. The ink 56 thus diffused oozes out of the perforations of the stencil sheet 18, and is transferred to the print sheets 37. In the manner described above, the ink image is printed on the print sheets 37 in the process where the print sheets 37 pass between the outer peripheral wall 53 of the drum 26 and the pressure roller 35. With regard to the print sheets 37 which have come out from between the outer peripheral wall 53 of the drum 26 and the pressure roller 35, the tip ends thereof are peeled off from the drum 26 by the sheet separator claw 44. The print sheets 37 spaced from the drum 26 are discharged through the conveying passage 45 to the paper receiving tray 46, and are stacked there.

During the printing operations, an extra ink which has flown downstream of the maximum printing area of the outer peripheral wall 53 flows into the ink recovery port 72 of the ink recovery device 73 and is recovered there.

When printing of the set number of print sheets is completed, the rotation of the outer peripheral wall 53 of the drum 26 is stopped, and the drive of the ink supplying device 54 is stopped. Thus, the supply of the ink 56 to the outer peripheral wall 53 is stopped. The drive of the ink recovery device 73 is stopped a little later than the stop of the ink supplying device 54, and the extra ink which has remained on the outer peripheral wall 53 is recovered through the ink recovery port 72. Moreover, the pressure roller 35 is recovered back to the standby position from the press position, and the stencil printing machine enters a standby mode.

When making of a new stencil sheet is started and so on and stencil disposal processing is thus started, the stencil clamping portion 27 of the drum 26 is shifted to a clamping release position, and the tip end of the stencil sheet 18, of which clamping has been released, is guided to the disposed stencil conveying device 47, following the rotation of the drum 26, and housed in the stencil disposal box 48.

As described above, in the stencil printing machine, the ink 56 is supplied to the outer peripheral wall 53 of the drum 26, and the ink 56 is squeezed by the pressing force of the pressure roller 35, thus being diffused on the outer peripheral wall 53. Moreover, the ink 56 thus diffused is transferred to the print sheets 37 from the perforations of the stencil sheet 18 by the pressing force of the pressure roller 35. Furthermore, the extra ink which is not used for the printing on the outer peripheral wall 53 of the drum 26 is recovered by the ink recovery device 73, and the extra ink thus recovered is recovered to the ink tank 57 of the ink supplying device 54. Hence, such a situation where the extra ink is degraded on the outer peripheral wall 53 of the drum 26 can be surely prevented to eliminate waste of the ink 56, and in addition, the recovered ink 56 can be automatically used for the next printing and after.

In the above-described embodiment, the ink supplying device 54 and the ink recovery device 73 are always driven during the printing mode. Accordingly, during the printing mode, the ink 56 is continuously supplied from the ink supply port 55 to the outer peripheral wall 53, and the ink 56 which has entered the ink recovery port 72 from the outer peripheral wall 53 is always recovered. Therefore, the ink 56 can be prevented from building up on the outer peripheral wall 53. Moreover, an adequate amount of the ink 56 can always be held on the outer peripheral wall 53, and accordingly, even when a large number of the print sheets are continuously printed, printed sheets with a desired ink density can be obtained.

Moreover, when the printing mode is finished, the drive of the ink recovery device 73 is stopped a little later than the stop of the drive of the ink supplying device 54. Accordingly, the extra ink cannot be allowed to remain in a substantially hermetically sealed space between the outer peripheral wall 53 of the drum 26 and the stencil sheet 18. Even if the extra ink remains, the extra ink 56 is held in the substantially hermetically sealed space between the outer peripheral wall 53 of the drum 26 and the stencil sheet 18, and a contact thereof with the atmosphere can be minimized. In the manner described above, the degradation of the extra ink 56 can be surely restricted even if the printing is not performed for a long time. Hence, such situation where the extra ink is degraded on the outer peripheral wall 53 of the drum 26 can be further prevented, and the waste of the ink 56 can be eliminated more effectively.

In the above-described embodiment, the ink supply port 55 as the ink supply unit is provided at the position upstream of the maximum printing area of the outer peripheral wall 53 in the printing direction. However, the ink supply port 55 may be provided at an upstream position within the maximum printing area of the outer peripheral wall 53 in the printing direction. The upstream position within the maximum printing area in the printing direction, where the ink supply port 55 is provided, is a concept including also a position on a border partitioning the maximum printing area and a non-printing area further upstream thereof, as well as a position described literally, which is upstream inside of the maximum printing area in the printing direction. Specifically, the upstream position within the maximum printing area in the printing direction, where the ink supply unit is formed, is a range where the ink 56 supplied to the surface of the outer peripheral wall 53 is at least diffusible onto the border partitioning the maximum printing area and the non-printing area further upstream thereof.

In the above-described embodiment, the ink recovery port 72 as the ink recovery unit is only provided at the position downstream of the maximum printing area of the outer peripheral wall 53 in the printing direction. However, a configuration may be adopted, in which ink recovery grooves are provided at outer positions on left and right sides of the maximum printing area in the perpendicular-to-printing direction N, and the ink recovery grooves are continued with the ink recovery port 72. With such a configuration, ink leaking from the sides of the maximum printing area can be recovered, and the ink leakage from the sides can be prevented. Moreover, another configuration may be adopted, in which an ink recovery groove is provided at a position which is upstream of the maximum printing area in the printing direction and downstream of the stencil clamping portion 27 in the printing direction, and the ink recovery groove is continued with the ink recovery port 72. With such a configuration, an ink leaking from the top of the maximum printing area can be recovered, and the ink leakage from the top can be prevented.

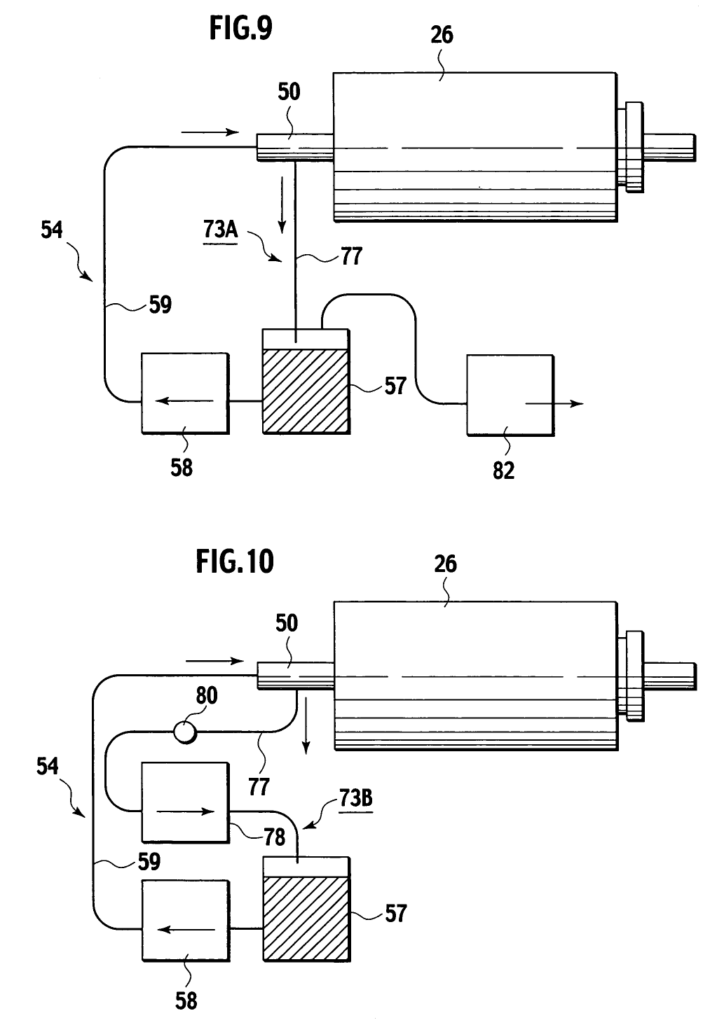

FIG. 9 shows a first modification example of the ink recovery device of the above-described embodiment, and is a schematic configuration view of the ink supplying device and the ink recovery device.

In FIG. 9, an in ink recovery device 73A of the first modification example, the other end of the fourth pipe 77 is connected to the ink tank 57 of the ink supplying device 54, and a vacuum (pressure-reducing) pump 82 which reduces pressure of the ink tank 57 is used as the ink pump.

Note that other configurations are similar to those of the above-described embodiment, and accordingly, the same reference numerals are assigned to the same constituent portions, and detailed description thereof is omitted.

Also in the case of using the ink recovery device 73A of the first modification example, in a similar way to the above-described embodiment, such situation where the extra ink is degraded on the outer peripheral wall 53 of the drum 26 can be surely prevented to eliminate the waste of the ink 56, and in addition, the recovered ink 56 can be automatically used for the next printing and after.

FIG. 10 shows a second modification example of the ink recovery device of the above-described embodiment, and is a schematic configuration view of the ink supplying device and the ink recovery device.

In FIG. 10, when comparing an ink recovery device 73B of the second modification example with the ink recovery device of the above-described embodiment, the ink recovery device 73B is different only in that a filter 80 which traps paper dust and the like is interposed midway through the fourth pipe 77.

Note that other configurations are similar to those of the above-described embodiment, and accordingly, the same reference numerals are assigned to the same constituent portions, and detailed description thereof is omitted.

Also in the case of using the ink recovery device 73B of the second modification example, in a similar way to the above-described embodiment, such situation where the extra ink is degraded on the outer peripheral wall 53 of the drum 26 can be surely prevented to eliminate the waste of the ink 56, and in addition, the recovered ink 56 can be automatically used for the next printing and after.

Moreover, the ink recovered from the outer peripheral wall 53 of the drum 26 passes through the filter 80, and impurities such as the paper dust in the ink are trapped by the filter 80. Hence, quality of the recovered ink can be improved.

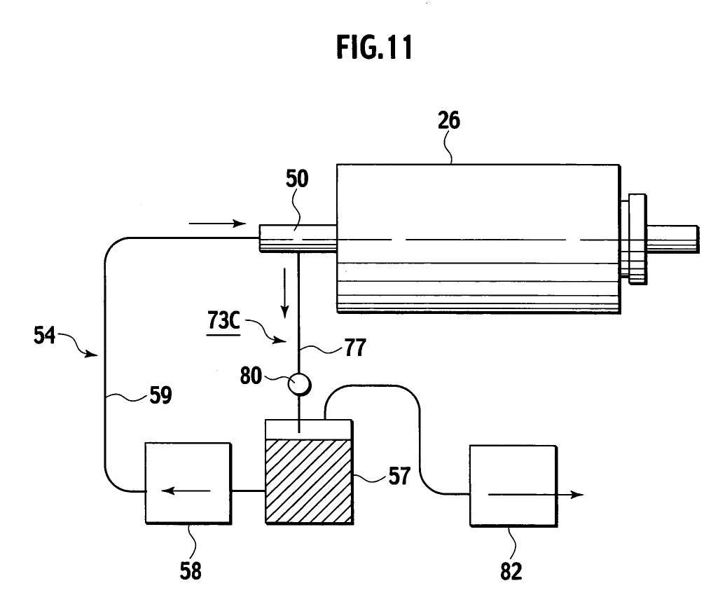

FIG. 11 shows a third modification example of the ink recovery device of the above-described embodiment, and is a schematic configuration view of the ink supplying device and the ink recovery device.

In FIG. 11, when comparing an ink recovery device 73C of the third modification example with the ink recovery device of the above-described first modification example, the ink recovery device 73C is different only in that the filter 80 which traps the paper dust and the like is interposed midway through the fourth pipe 77.

Note that other configurations are similar to those of the above-described embodiment, and accordingly, the same reference numerals are assigned to the same constituent portions, and detailed description thereof is omitted.

Also in the case of using the ink recovery device 73C of the third modification example, in a similar way to the above-described embodiment, such situation where the extra ink is degraded on the outer peripheral wall 53 of the drum 26 can be surely prevented to eliminate the waste of the ink 56, and in addition, the recovered ink 56 can be automatically used for the next printing and after.

Moreover, the ink recovered from the outer peripheral wall 53 of the drum 26 passes through the filter 80, and the impurities such as the paper dust in the ink are trapped by the filter 80. Hence, the quality of the recovered ink can be improved.

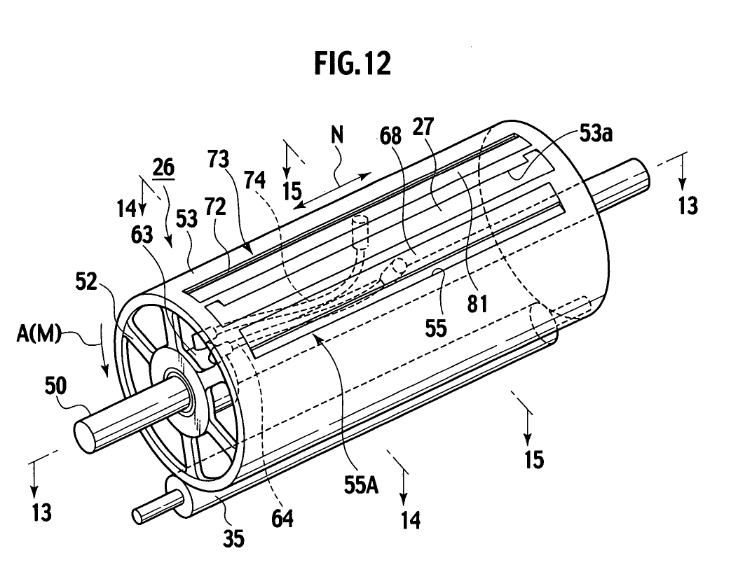

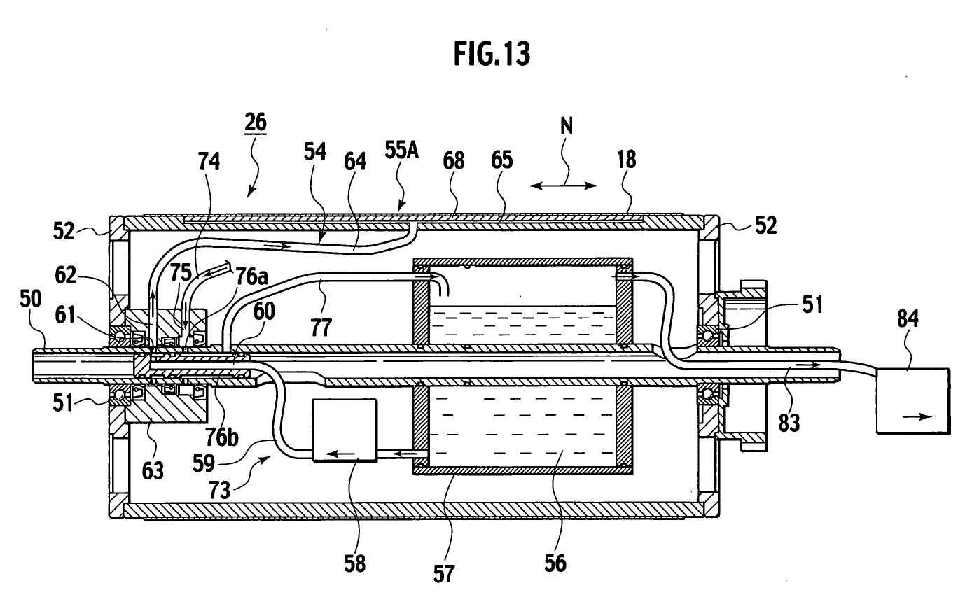

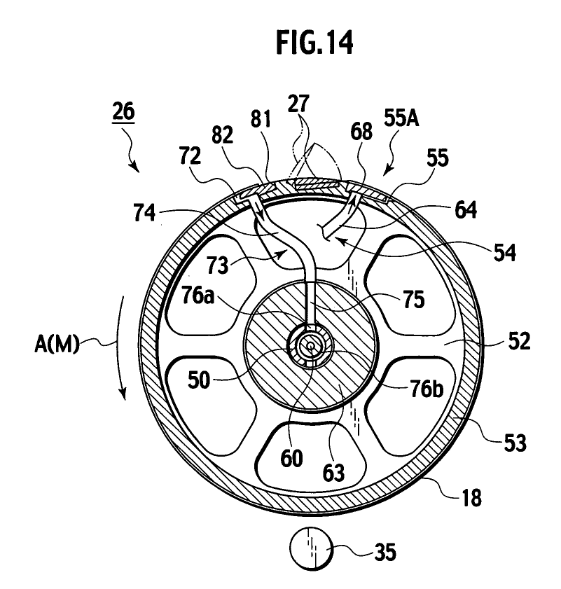

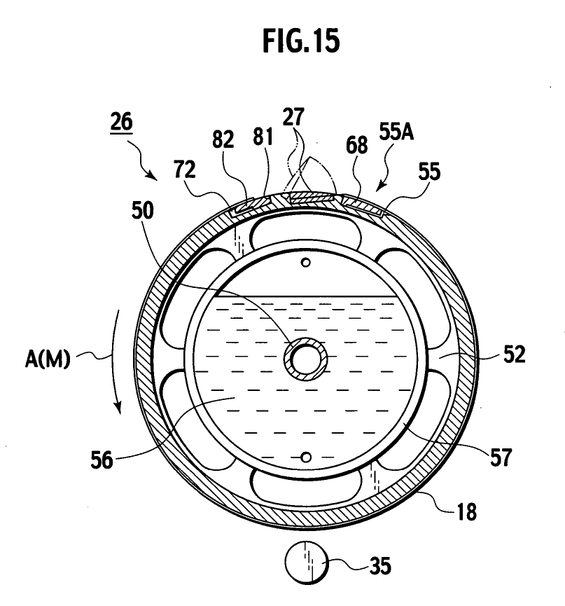

FIG. 12 to FIG. 15 show a second embodiment of the present invention. FIG. 12 is a perspective view of a drum. FIG. 13 is a cross-sectional view along a line 13-13 in FIG. 12. FIG. 14 is a cross-sectional view along a line 14-14 in FIG. 12. FIG. 15 is a cross-sectional view along a line 15-15 in FIG. 12.

As shown in FIG. 12 to FIG. 15, in the second embodiment, the ink recovery device 73 which recovers the ink 56 having leaked from the maximum printing area of the outer peripheral wall 53 is placed in the drum 26.

The ink recovery device 73 is composed of the ink recovery port 72 as the ink recovery unit provided at the downstream position of the maximum printing area of the outer peripheral wall 53 of the drum 26 in the printing direction, the third pipe 74 in which one end is connected to the ink recovery port 72, the rotary joint 63 to which the other end of the third pipe 74 is connected and in which the communication hole 75 is formed, the support shaft 50, the fourth pipe 77 in which one end is connected to the support shaft 50, a supply tank 57 as a recovery tank to which the other end of the fourth pipe 77 is connected, a fifth pipe 83 in which one end is connected to an upper end of the supply tank 57 and which is guided to the outside of the drum 26 through the inside of the support shaft 50, and a recovery pump 84 of a vacuum pump type, which is connected to the other end of the fifth pipe 83 and reduces pressure in the supply tank 57. Here, regarding the support shaft 50, the rotary joint 63 is supported thereon so as to be freely rotatable, the hole 76a to which the communication hole 75 is connectable is formed therein, and the ink passage 76b is formed in the inside thereof. The parts of the ink recovery device 73 except the recovery pump 84 and a part of the fifth pipe 83 are housed in the drum 26.

The ink recovery port 72 is formed by use of an ink recovery concave portion 81 formed on the outer peripheral wall 53, and of the pipe fixing member 82 placed in the inside thereof. The rotary joint 63 is made to also function as one for the ink supplying device 54. The support shaft 50 is also used for the ink passage of the ink supplying device 54, and accordingly, adopts the structure of a double pipe. Moreover, in the second embodiment, a configuration is adopted, in which the supply tank 57 of the ink supplying device 54 also functions as the recovery tank of the ink recovery device 73, and the recovered ink in the ink recovery device 73 is recovered to the supply tank 57.

Note that other configurations are the same as those of the above-described first embodiment, and accordingly, the same reference numerals are assigned to the same constituent portions, and detailed description thereof is omitted.

Also in this second embodiment, it is not necessary to place, in the drum 26, the various rollers and the ink pools, which are for supplying the ink, as in the conventional examples. Accordingly, a large space for placing the supply tank 57 can be reserved in the drum 26 as described in this second embodiment.

In this second embodiment, the ink recovery device 73 which recovers the extra ink on the surface of the outer peripheral wall 53 from the ink recovery port 72 provided on the outer peripheral wall 53 of the drum 26 is provided, and the supply tank 57 is placed in the drum 26. Accordingly, the extra ink which is not used for the printing on the outer peripheral wall 53 of the drum 26 is recovered by the ink recovery device 73, and the extra ink thus recovered is recovered into the supply tank 57. Hence, such situation where the extra ink is degraded on the outer peripheral wall 53 of the drum 26 can be surely prevented to eliminate the waste of the ink 56, and in addition, the ink 56 can be reused. Moreover, the ink recovery passage is shortened to reduce flow resistance, and efficiency of recovering the ink is increased. Accordingly, the recovery pump 84 of which performance is low is sufficient.

In this second embodiment, the recovery tank is the supply tank 57 of the ink supplying device 54. Accordingly, the recovered extra ink is recovered into the supply tank 57 of the supplying device 54. Hence, the recovered ink 56 can be automatically used for the next printing and after.

Note that, in this second embodiment, the supply tank 57 of the ink supplying device 54 is utilized as the recovery tank, and accordingly, only the supply tank 57 is placed in the drum 26. However, a configuration may be adopted so that the supply tank 57 and the recovery tank are individually housed in the drum 26.

In this second embodiment, the vacuum-type pump is adopted as the recovery pump 84, and accordingly, a configuration is adopted so that the recovery pump 84 is placed outside of the drum 26. However, if a trochoid-type pump, which can be interposed in the fourth pipe 77 and capable of suctioning the ink 56 in the ink recovery port 72 to the supply tank 57, is adopted as the recovery pump, the recovery pump 84 can be placed in the drum 26. Moreover, if all the parts of the ink recovery device 73 are placed in the drum 26, a detachment of the drum 26 is not accompanied with a detachment of the ink recovery passage. Accordingly, it is not necessary to take measures for preventing the ink leakage. Furthermore, the ink recovery passage is shortened to reduce the flow resistance, and the efficiency of recovering the ink is increased. Accordingly, there is an advantage in that the recovery pump 84 of which performance is low is sufficient and so on.

In this second embodiment, if the ink supplying device 54 and the ink recovery device 73 are controlled so as to be always driven during the printing mode, the ink is continuously supplied from the ink supply unit 55A to the outer peripheral wall 53 during the printing mode, and the ink 56 which has entered the ink recovery port 72 from the outer peripheral wall 53 is always recovered. Accordingly, the ink 56 can be prevented from building up on the outer peripheral wall 53 as soon as possible. Moreover, the adequate amount of the ink 56 can always be held on the outer peripheral wall 53. Therefore, even when the large number of print sheets are continuously printed, printed sheets with the desired ink density can be obtained.

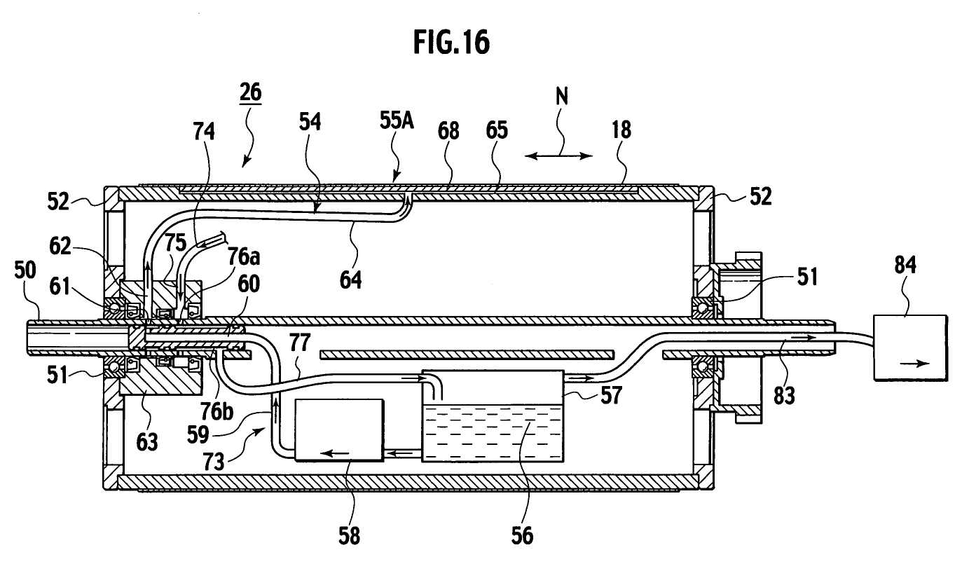

FIG. 16 shows a third embodiment, and is a cross-sectional view of the drum 26. FIG. 16 shows a case where the supply tank 57 of the ink supplying device 54, which is also the recovery tank, is smaller with respect to the inner space of the drum 26. The supply tank 57 is placed in the drum 26 and at a position below the support shaft 50. Other configurations are similar to those of the above-described second embodiment, and accordingly, the same reference numerals are assigned to the same constituent portions, and detailed description thereof is omitted.

According to the third embodiment, it is not necessary to place, in the drum 26, the various rollers and the ink pools, which are for supplying the ink, as in the above-described second embodiment. Hence, when the space for the supply tank 57 is smaller with respect to the inner space of the drum 26, there is an advantage in that a degree of freedom in placing the supply tank 57 as the recovery tank is high because the supply tank 57 can be placed at a desired position (lower position in the drum 26 in this embodiment) in the drum 26.

1. A stencil printing machine, comprising:
a drum which is freely rotatable and has an outer peripheral wall formed of an ink impermeable member, in which a stencil sheet is mounted on a surface of the outer peripheral wall;
an ink supply device which has an ink supply unit provided on the outer peripheral wall of the drum and has an ink tank storing an ink, and supplies the ink from the ink supply unit to the surface of the outer peripheral wall, the ink being guided from the ink tank;
an ink recovery device which has an ink recovery unit on the outer peripheral wall of the drum, and recovers, from the ink recovery unit, an extra ink on the surface of the outer peripheral wall; and
a pressure roller which presses a print medium fed thereto to the outer peripheral wall,
wherein the ink recovery device recovers, to the ink tank, the extra ink recovered from the ink recovery unit.

2. The stencil printing machine according to claim 1,
wherein a filter which traps impurities in the ink is interposed in a passage for recovering the ink from the ink recovery unit to the ink tank.

3. The stencil printing machine according to claim 1,
wherein the ink supply device and the ink recovery device are always driven during a printing mode.

4. The stencil printing machine according to claim 3,
wherein a drive of the ink recovery device is stopped a little later than a stop of a drive of the ink supply device when the printing mode is finished.

5. The stencil printing machine according to claim 1,
wherein the ink tank is placed in the drum.
